(19) United States
(12) Patent Application Publication
(10) Pub. No.: US 2014/0370780 A1
(43) Pub. Date: Dec. 18, 2014

(54) Deer Cutter

(71) Applicant: Richard Leroy Cologie, Thornville, OH (US)

(72) Inventor: Richard Leroy Cologie, Thornville, OH (US)

(21) Appl. No.: 13/917,615

(22) Filed: Jun. 13, 2013

(51) Int. Cl. A01M 31/00

(52) U.S. Cl. CPC A01M 31/004
USPC 446/397

(57) ABSTRACT

The Deer Cutter is a hand held friction device that replicates the sound of a squirrel cutting/feeding on a nut. This invention creates a cutting sound that deer and other wild animals listen for to ensure the area is free from danger or threats. The Deer Cutter has been field tested for two years and has shown success in luring in deer, turkeys, coyotes and squirrels. The device consists of a spear/arrowhead shaped device with a stainless steel grate in the center that create the desired cutting sound when stricken with the brass striker stick. The Deer Cutter is the only device that creates a false environment by creating the cutting sound.

This invention relates to the present invention of the Deer Cutter. The invention consists of a variety of wood articles cut into the shape of a spear/arrowhead, stainless steel grater and brass striker stick used as a friction device to create the sound of a squirrel cutting. The invention is one of a kind and used for hunting by creating a false environment that deer perceive as safe enough for a squirrel to feed.

### FEDERALLY SPONSORED RESEARCH OR DEVELOPMENT

Not Applicable

### REFERENCE TO SEQUENCE LISTING, TABLE, OR COMPUTER PROGRAM LISTING COMPACT DISC APPENDIX

Not Applicable

### BACKGROUND OF THE INVENTION

The Deer Cutter is a hand held friction device used to lure in deer by creating a false sense of security. This present invention is the only one of its kind, there are no other games calls that create this sound or false environment to lure in deer. Currently game calls are used to attract deer by creating the perception that another deer is nearby. Game calls today consist of mouth calls, bleat cans, rattling, and electronic calls that lure in deer by imitating the noises that are commonly used for deer to communicate or show dominance.

Game calls are an essential tool for hunters. The current devices today range from small mouth pieces that imitate the sounds of bucks and does to bulky devices such as antlers used for rattling. Large devices used for game calls can be inconvenient for hunters when traveling and conducting the call.

Studies have shown that hunters prefer game calls that are portable and convenient for traveling to and from woods, fields, and blinds. It is also important for the calls to be influenced by the hunter, to ensure the desired level and proper amount of use to create the false environment. Hunters also want a device that is easily assessable such as mouth pieces or devices that fit around their necks. These smaller devices are convenient when drawing the deer in closer and quickly accessing their weapon.

### BRIEF SUMMARY

The Deer Cutter is a spear shaped, hand held friction device that creates the sound of a squirrel cutting or feeding on a nut. This invention creates a deception that the environment is safe enough for a squirrel to comfortably feed. The Deer Cutter is successful game call due to the cutting noise, a subconscious sound that deer associate with safety.

Hunters prefer game calls that they can change or enable to accurately execute the illusion. The invention is a versatile device that creates numerous pitches based on the speed and angle the device is being held. Simply drag the striker across the stainless steel grater in the desired sequence and the sound of a squirrel cutting a nut or feeding on a piece of corn is created.

The Deer Cutter also solves the convenience and portably problem that other devices have shown. The Paracord that the hand held spear shaped device and striker are attached to makes accessing, transportation and quickly assessing weapons convenient.

### BRIEF DESCRIPTION OF THE SEVERAL VIEWS OF THE DRAWING

The drawings section attached shows details and structure of the Deer Cutter. FIG. 1A in the drawings sections depicts the spear/arrowhead shaped hand held wood device. The spear/arrowhead shape is made from a variety of woods then finished with a dark walnut Danish oil finish to protect the device from the environment and give a finished look.

FIG. 2A in the drawings section is a description of the stainless steel grater located in the center of the spear shaped wooden device. This stainless steel grater has been made with numerous punctures or holes with rough or sharpened edges that are the essential part of creating the desired cutting noise. The stainless steel graters are painted with an earth brown ultra flat paint to accent the spear shaped wood and protect the grater. The edges of the stainless steel grater are shown in larger detail in FIG. 1B.

FIGS. 3A and 4A in the drawings section are used to illustrate the small brass bar (FIG. 3A) and the ⅜″ shrink tube (FIG. 4A) that make up the striker stick. The small brass bar is used to alter the speed and pressure of the strike on the grater resulting in the desired cutting sound.

FIG. 5A of the drawings section is used to portray the large Paracord that is wrapped/tied to the bottom of the spear shaped wood device. The large Paracord is tied at the top to create a necklace/lanyard.

FIG. 6A in the drawings section is used to depict the micro cord that attaches the spear shape wood to the striker stick. FIGS. 2B and 3B represent the holes drilled into the wooden device and the striker stick to attach the micro cord.

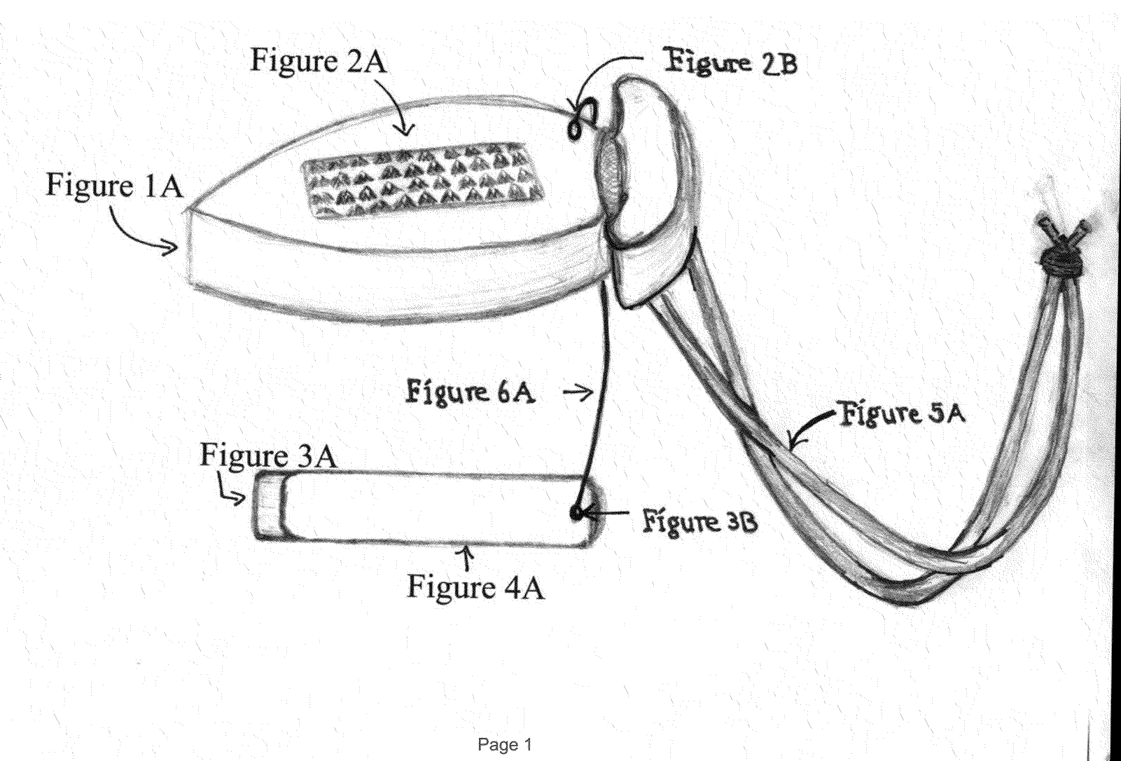

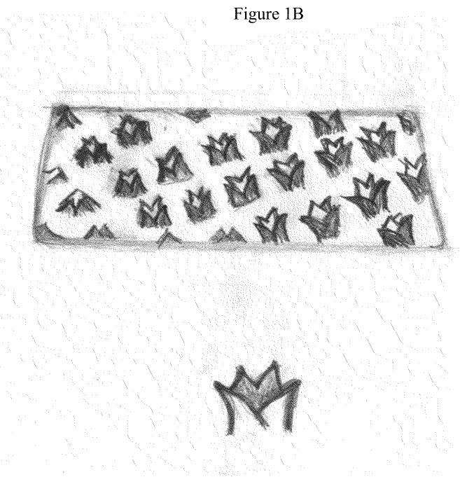

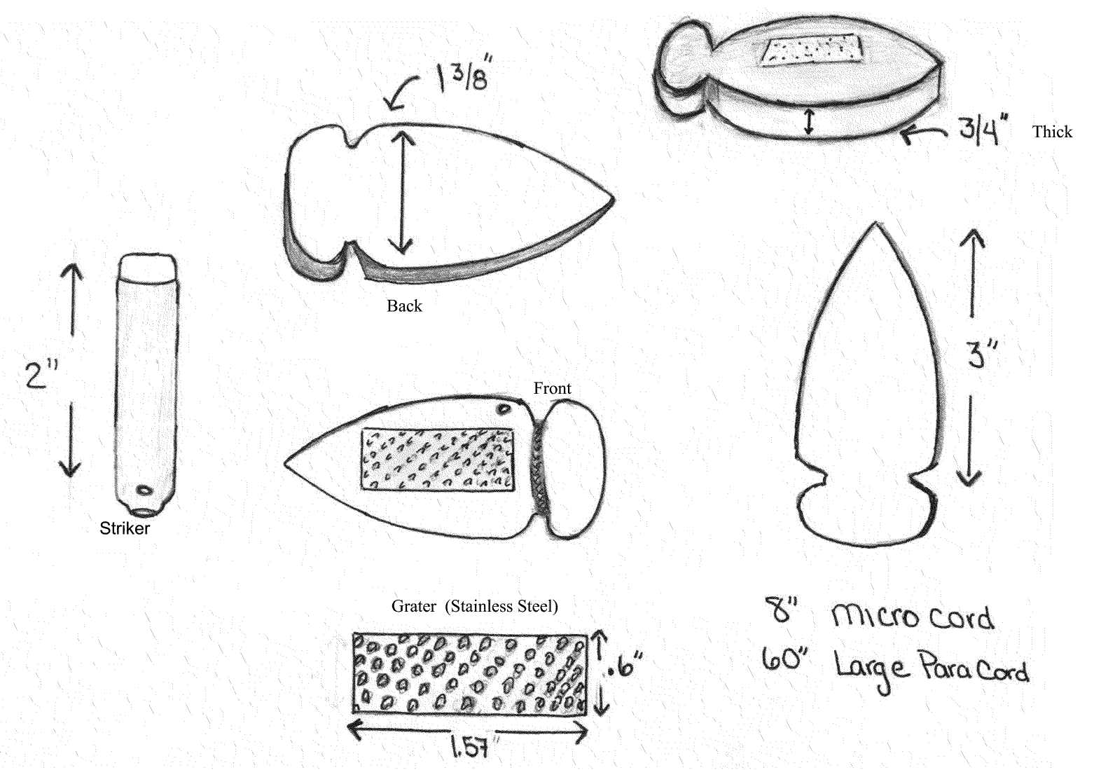

### DETAILED DESCRIPTION

The Deer Cutter is an invention created to simulate a safe environment for wild game in the area. The device creates the sound of a squirrel cutting or feeding on a nut by striking the stainless steel grate with the hand held striker in the desired sequence. This sound is one that deer subconsciously associate with safety. The Deer Cutter has been field tested for two years and has shown success in luring in deer, turkeys, squirrels and coyote.

The invention is successful because it creates the environment that deer and other wild game are most comfortable in. When a hunter travels into the woods he is noticed by the small creatures that change their behavior due to the unwanted presence of the hunter. Squirrels alert the forest to these unwanted intruders by stopping their natural behavior such as feeding/cutting and instead focus on watching the threat. The Deer Cutter recreates the natural behavior to calm the woods and bring back the sense of security that draws in wild game.

The Deer Cutter design is the only device in existence that creates a false environment by creating the sounds of squirrels cutting or feeding. This invention is unique in the game calling field as it separates itself from other calls by replicating a false environment that imitates a safe atmosphere using the sounds made by squirrels. Currently Deer game calls only replicate the sounds that deer would make in their environment. The game calls today focus on luring in deer by creating the false sense that another deer is nearby. The Deer Cutter doesn't create the perception of other deer, it creates the safe environment that all wild animals search for.

To create the call the hunter simply holds the wooden hand held spear shaped device in one hand pointing away from the body and strikes the metal portion of the device with the striker stick that is held in the opposite hand. The sound is versatile and can be changed by the angle the hunter holds the device and how quickly the metal portion is stricken. A normal sequence that creates the cutting sound is accomplished by striking the metal device in the sequence, 1,2, −1,2,3,4,5, −1,2,3, −1,2, −1,2,3, −1,2,3,4,5, etc.

The Deer Cutter is manufactured with an automatic wood cutting machine that creates the spear shaped designed. The hand held wooden spear shaped device is made from a variety of wood types that is cut down to the spear shape. The spear shape is approximately ¾ of an inch thick, 3″ in length and 1⅜″ in width tapering to a point. The wood has been treated with Dark Walnut Danish Oil Finish before inserting the steel grater. The metal grater that creates the call is painted with earth brown ultra flat paint, and then cut into 1.57″ in length by 0.6″ in width slabs that are inserted and glued into the center of the spear shaped device. The hand held striker is approximately 2″ length is made from brass wrapped in a ⅜″ shrink tube. The striker and spear shaped device are connected by 8″ of Para micro cord with the spear shaped device tied to 60″ Para cord for the purpose of being worn around the neck.

What I claim is:

1. A hand held friction device that mimics the sound of a squirrel feeding or cutting a nut and consisting of the following:
A wooden hand held spear/arrowhead shaped device, stainless steel grater, and brass striker stick wrapped in shrink tube connected together with 1 large Para cord and 1 small micro cord.

2. The hand held friction device of claim 1, wherein said the device consists of 1 wooden spear/arrowhead shaped device made from a variety of wood types and stained with an oil finish.

3. Hand held friction device of claim 2, wherein said the device consists of 1 stainless steel grate consisting of a piece of stainless steel with small opened edged dents/holes inserted into spear/arrowhead shaped device and painted an accent color.

4. Hand held friction device of claim 2, wherein said the stainless steel grate is used to create the specified cutting noise based on the pressure and speed of sticking with the striker stick.

5. Hand held friction device of claim 3, wherein said the device consists of a small brass bar wrapped in shrink tube, used to strike the stainless steel grate.

6. Hand held friction device of claim 4, wherein said the device consists of 1 small micro cord to connect the spear shaped device and the striker stick.

7. Hand held friction device of claim 5, wherein said the device consists of 1 large Paracord wrapped/tied around the spear shaped device and looped at top to create a necklace/lanyard.
